(19) United States
(12) Patent Application Publication
(10) Pub. No.: US 2019/0043078 A1
(43) Pub. Date: Feb. 7, 2019

(54) MODEL-BASED RESOURCE-AWARE RESOURCE REDUCTION REQUEST AMOUNT SUGGESTION FOR CONTENT ITEMS

(71) Applicant: Microsoft Technology Licensing, LLC, Redmond, WA (US)

(72) Inventors: Lin Ma, San Jose, CA (US); Lijun Peng, Sunnyvale, CA (US); David Merrill Pardoe, Mountain View, CA (US); Gaurav Chandalia, Fremont, CA (US); Kun Liu, San Jose, CA (US)

(21) Appl. No.: 15/669,773

(22) Filed: Aug. 4, 2017

(51) Int. Cl. G06Q 30/02; H04L 29/08

(52) U.S. Cl. CPC G06Q 30/0244; H04L 67/02; H04L 67/22; G06Q 30/0277

(57) ABSTRACT

A system comprises servers comprising processors and memory storing instructions which, when executed by the processors, cause the processors to perform: receiving, from a content provider, a request to begin a content delivery campaign, the request comprising targeting criteria and a resource amount, prior to beginning the content delivery campaign, determining, based on the targeting criteria, historical results of content item selection events, prior to beginning the content delivery campaign, determining, based on the targeting criteria, a suggested resource reduction request amount using the historical results and the resource amount, causing the suggested resource reduction request amount to be displayed to the content provider, receiving, from the content provider, a particular resource reduction request amount for the content delivery campaign, initiating the content delivery campaign using the particular resource reduction request amount.

### TECHNICAL FIELD

The present disclosure relates to electronic content delivery and, more particularly, to providing a suggested resource reduction request amount. SUGGESTED ART UNIT: 2161; SUGGESTED CLASSIFICATION: 707/776.

### BACKGROUND

The Internet has enabled the delivery of electronic content to billions of people. Such delivery can be made through many different channels. Even the same content may be delivered to many end-users through different channels. Some entities maintain content delivery exchanges that allow different content providers to reach a wide online audience. There is a limit to the resources that are dedicated to each content delivery campaign that a content provider establishes with a content delivery exchange. The resources dedicated to a content delivery campaign should, to the extent possible, be optimally allocated. However, in practice, this is challenging to accomplish, and improvements are needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates an example computer system in which the techniques described herein may be practiced, in an embodiment.

FIG. 2 illustrates a programmable algorithm or method for resource-aware resource reduction request amount suggestions in accordance with an embodiment.

FIG. 3 illustrates an example screenshot in accordance with an embodiment.

FIG. 4 illustrates a computer system upon which an embodiment may be implemented.

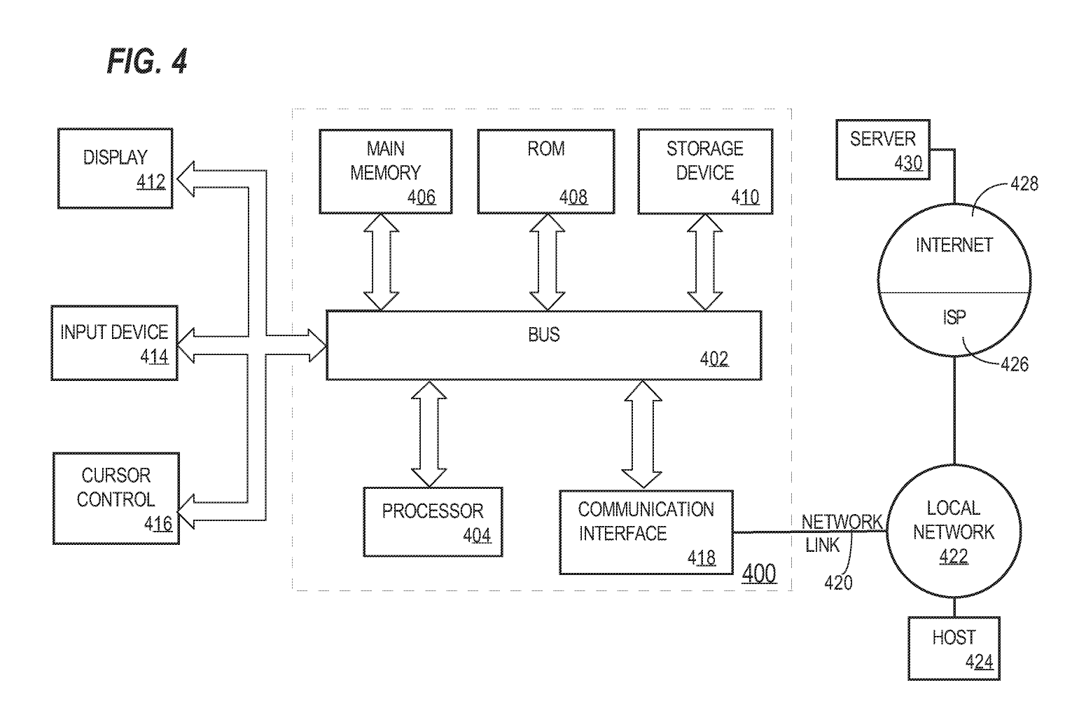

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

### System Overview

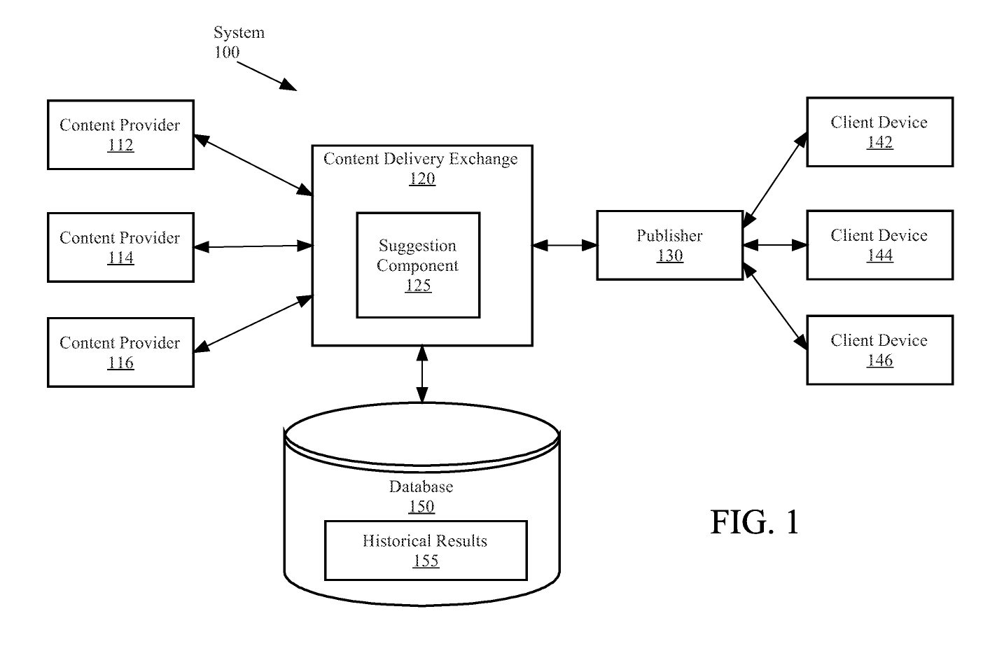

FIG. 1 is a block diagram that depicts a system 100 for distributing content items to one or more end-users, in an embodiment. System 100 includes content providers 112, 114, and 116, a content delivery exchange 120 which includes suggestion component 125, a publisher 130, client devices 142, 144, and 146, and database 150 which includes historical results 155. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Although depicted in a single element, content delivery exchange may comprise multiple computing elements and devices, connected in a local network or distributed regionally or globally across many networks, such as the Internet. Thus, content delivery exchange 120 may comprise multiple computing elements, including file servers and database systems.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

In response to receiving a content request, content delivery exchange 120 initiates a content item selection event that involves selecting one or more content items (from among multiple content items) to present to the client device that initiated the content request. An example of a content item selection event is an auction.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Thus, content delivery exchange 120 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery campaign 120 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different charge models. For example, content delivery exchange 120 may charge a content provider of one content delivery campaign for each presentation of a content item from the content delivery campaign (referred to herein as cost per impression or CPM). Content delivery exchange 120 may charge a content provider of another content delivery campaign for each time a user interacts with a content item from the content delivery campaign, such as selecting or clicking on the content item (referred to herein as cost per click or CPC). Content delivery exchange 120 may charge a content provider of another content delivery campaign for each time a user performs a particular action, such as purchasing a product or service, downloading a software application, or filling out a form (referred to herein as cost per action or CPA). Content delivery exchange 120 may manage only campaigns that are of the same type of charging model or may manage campaigns that are of any combination of the three types of charging models.

A content delivery campaign may be associated with a budget or “resource amount” that indicates how much the corresponding content provider is willing to be charged by content delivery exchange 120, such as $100 or $5,200. A content delivery campaign may also be associated with a resource reduction request amount that indicates how much the corresponding content provider is willing to be charged for each impression, click, or other action. For example, a CPM campaign may request to reduce their resource budget by five cents for an impression, a CPC campaign may request to reduce their resource budget by five dollars for a click, and a CPA campaign may request to reduce their resource budget by five hundred dollars for a conversion (e.g., a purchase of a product or service).

### Content Item Selection Events

As mentioned previously, a content item selection event is when multiple content items are considered and a subset selected for presentation on a computing device in response to a request. Thus, each content request that content delivery exchange 120 receives triggers a content item selection event.

Specifically, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price (referred to herein as a “resource reduction request amount”). Each content delivery campaign may be associated with a resource reduction request amount that represents how much the corresponding content provider is willing to pay (e.g., content delivery exchange 120) for having a content item of the campaign presented to an end-user or selected by an end-user. Different content delivery campaigns may have different resource reduction request amounts. Generally, content delivery campaigns associated with relatively higher resource reduction request amounts will be selected for displaying their respective content items relative to content items of content delivery campaigns associated with relatively lower resource reduction request amounts. Other factors may limit the effect of resource reduction request amounts, such as objective measures of quality of the content items (e.g., actual click-through rate (CTR) and/or predicted CTR of each content item), resource pacing (which controls how fast a campaign's resources are used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including resource reduction request amount of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the resource reduction request amounts of each content item that was part of the content item selection event. Thus, the other exchange may provide, to content delivery exchange 120 (or to a performance simulator described in more detail herein), information regarding one or more resource reduction request amounts and, optionally, other information associated with the content item(s) that was/were selected during a content item selection event, information such as the minimum winning resource reduction request amount or the highest resource reduction request amount of the content item that was not selected during the content item selection event.

### Historical Content Item Selection Event Results

Content delivery exchange 120 tracks any of the above, or below, mentioned data relating to content item selection events and tracking user interactions, and stores the data in database 150 as historical results 155. Specifically, while raw data may be stored, either permanently or temporarily, historical results 155 includes compiled, aggregated or otherwise processed data that may be used to perform various calculations, such as in improving suggested resource reduction request amounts. Historical results 155 may be compiled, aggregated, or otherwise processed in any manner, and at any time. Historical results 155 may include data from any time period, such as from the beginning of content delivery exchange 120, or may include data from a more limited, recent time period, such as the past year, past 6 months, etc. Historical results 155 may include data from any number of different content delivery campaigns from many different content providers.

In one embodiment, historical results 155 may include, but is not limited to: winning resource reduction request amount distribution for all campaigns, winning resource reduction request amount for predetermined ranges of resource amounts (e.g., buckets for resource amounts), a distribution of resource reduction request amounts across all campaigns or within groups of campaigns (such a particular region or industry), number of requests for a given targeting criteria, predicted CTR for a given targeting criteria, average resource cost for a given targeting criteria, a winning rate for a given targeting criteria, impression volume for a given targeting criteria, campaign CTR, other campaign specific data, etc. Average resource cost may be calculated as

average resource cost=∫₀^{RRRA} max(x, floor)p(x)dx/∫₀^{RRRA} p(x)dx

where RRRA stands for the resource reduction request amount, p(x) is the probability density function of x being the top resource reduction request amount, floor is a minimum resource cost for the campaign.
Campaign CTR may be calculated as

$$Campaign CTR = \frac{campaign click + α * segment clicks + β}{campaign impressions + α * segment impressions + γ}$$

where α is a variable, β is a variable, and γ is a variable. The variables are used for tuning, and may be any suitable value. In one embodiment, the variables may be global for all campaigns. Alternatively, the variables may be specific for one campaign or a set of campaigns.

### Tracking User Interactions

Content delivery exchange 120 tracks one or more types of user interactions across client devices 142-146 (and other client devices not depicted). For example, content delivery exchange 120 determines whether a content item that content delivery exchange 120 delivers is presented at (e.g., displayed by or played back at) a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device.

### Suggesting Resource Reduction Request Amounts

In one embodiment, suggestion component 125 receives content delivery campaign requests from content providers 112-116. Suggestion component 125 is implemented in software, hardware, or any combination of software and hardware. The content delivery campaign requests may be received at any time, and in any format or manner, such as through one or more interfaces or forms within a website or application. The content delivery campaign requests may include many different elements or data relating to a content delivery campaign, such as any of those discussed above. In particular, the request includes at least one or more targeting criteria and a resource amount. The resource amount indicates how many resources the content provider would like to use on the content delivery campaign. The resource amount may be a total amount, a daily amount, a weekly amount, or may correspond to any other amount of time.

In one embodiment, suggestion component 125 determines or identifies historical results related to content delivery campaigns. The historical results may be retrieved from database 150, or may be generated in response to a request, or some combination of both retrieved from database 150 and generated in response to a request.

In one embodiment, suggestion instructions 125 determines a suggested resource reduction request amount. In particular, the suggested resource reduction request amount takes the resource amount of the content provider into consideration. The resource amount may be processed in any manner, if needed, to determine a daily resource amount. The suggested resource reduction request amount is a suggested amount that should cause the daily resource amount to be efficiently used. Depending on the availability of certain data items or other factors, the suggested resource reduction request amount may be determined in many different ways. The suggested resource reduction request amount may be a specific amount, such as $8.63. Alternatively, the suggested resource reduction request amount may be a range, such as $4.13 to $4.89. Further still, the suggested resource reduction request amount may include both a range and a specific amount. For example: “the suggested resource reduction amount is $6.28, or any amount from $5.23 to $7.46.”

In one embodiment, the suggested resource reduction request amount is determined in part using predefined ranges, such as buckets. Any number of buckets may be used, and the buckets may cover any predefined range of resource amounts. Further, the buckets may be of the same size or may vary in size. For example, the buckets may be a $10 range from 0 to $100 daily resource amount and may then change to a $25 range from $100 to $200. As part of determining the suggested resource reduction amount in this embodiment, the daily resource amount for the content delivery campaign is identified and associated with a corresponding bucket. A winning resource reduction request amount distribution is used to identify a lower percentile and higher percentile of the winning resource reduction request amount distribution. The lower percentile and the higher percentile are modified based on the bucket associated with the campaign. For example, for a bucket associated with a relatively large daily resource amount, the lower percentile and the higher percentile may be adjusted higher, while for a bucket associated with a relatively small daily resource amount, the lower percentile and the higher percentile may be adjusted lower. Alternatively, each bucket may have a separate winning resource reduction request amount distribution which may be used instead. This embodiment may be used without knowing any performance data of the content delivery campaign.

In one embodiment, determining a suggested resource reduction request amount involves predicting resource usage. Predicted resource usage may be calculated as: requests*winning rate*predicted CTR*average resource reduction request amount, where requests are the daily average requests from users that satisfy the targeting criteria, winning rate is the historical winning resource request amount distribution, predicted CTR is an average CTR for the content exchange or for a target audience that satisfies the targeting criteria associated with the campaign, and average resource reduction request amount is calculated as discussed above. If the campaign is a CPM campaign, the formula used may be calculated as: requests*winning rate*average resource reduction request amount. Using the above, a resource reduction request amount which is predicted to use the daily (or other timeframe) resource amount may be identified. In other words, for a given daily resource amount, the resource reduction request amount that results in using (or spending) the daily resource amount is searched for and identified. This embodiment may be used without knowing any performance data of the content delivery campaign.

In one embodiment, determining a suggested resource reduction request amount is more accurate when performance data of the content delivery campaign is known (i.e., the content delivery campaign has begun and data is available). When performance data about the content delivery campaign is known, resource usage may be predicted as: impression volume*campaign CTR*average resource reduction request amount, where impression volume is an impression forecast for the targeting criteria (the impression forecast may be a simulated value based in part on actual results of the content deliver campaign, or may be determined in any other way)+the content delivery campaign's impression share at the given resource reduction request amount, campaign CTR is calculated as discussed above, and average cost is calculated as discussed above. If a suggested resource reduction request amount has been previously determined, then the suggested resource reduction request amount may be updated.

In one embodiment, suggestion component 125 displays the suggested or updated resource reduction request amount. The suggested resource reduction request amount may be displayed in any manner, at any time. For example, the suggested resource reduction request amount may be displayed during creation of a content delivery campaign, next to or near where the resource reduction request amount may be entered for the content delivery campaign by a user (or representative of the content provider).

In one embodiment, content delivery exchange 120, or any other suitable component, receives a resource reduction request amount from a client device and uses the resource reduction request amount in the content delivery campaign. The received resource reduction request amount may correspond to the suggested resource reduction request amount, or may be some other amount. The received resource reduction request amount may be in any format and may be received in any manner at any time. Once received, the resource reduction request amount may be used to initiate a content delivery campaign, or may be used to update an existing content delivery campaign, such as increasing or decreasing the resource reduction request amount.

### Example Process

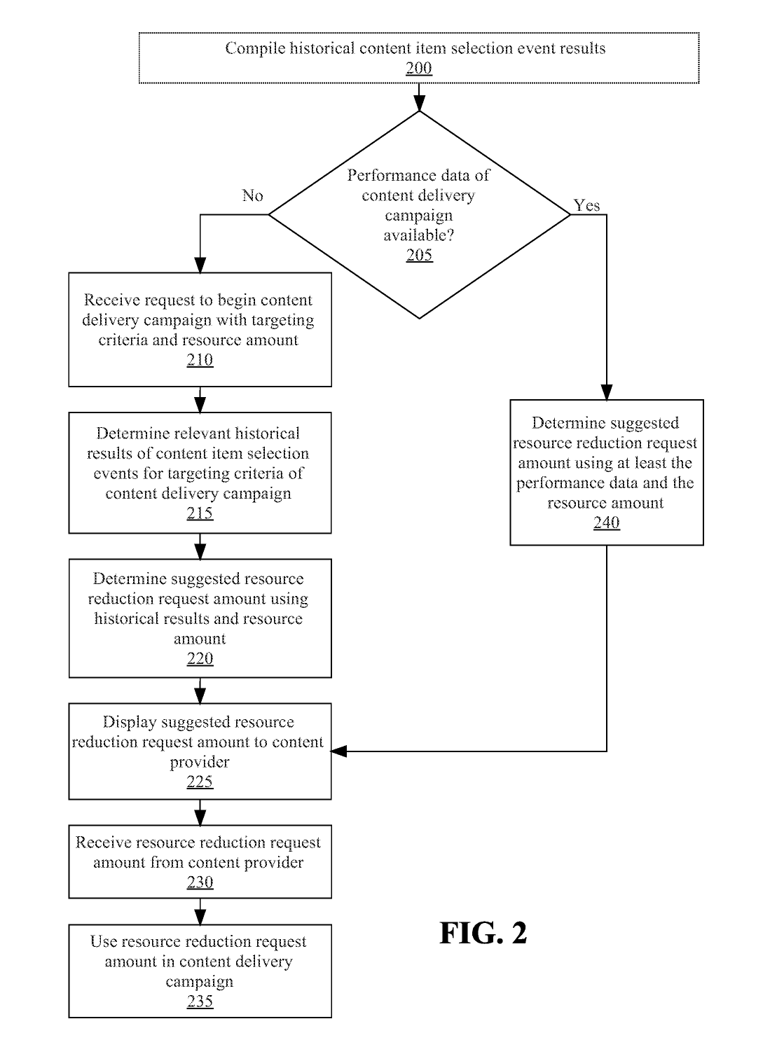

FIG. 2 illustrates an example programmable algorithm or method for resource-aware resource reduction request amount suggestions. Although the steps in FIG. 2 are shown in an order, the steps of FIG. 2 may be performed in any order, and are not limited to the order shown in FIG. 2. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments, at the same level of detail that is used by persons of ordinary skill in the art to which the disclosure pertains for communicating with one another about similar computer programs or algorithms. In other words, each flow diagram in this disclosure is a guide, plan or specification of an algorithm for programming a computer to execute the functions that are described.

In step 200, historical results of content item selection events are compiled or otherwise determined. As indicated by the dotted lines, the historical results may be compiled, calculated, or processed at any time, and may continue to be updated during the method shown in FIG. 2. The historical results may be for any time period, such as since the beginning of the content delivery exchange, or for a rolling window, such as the most recent six months. Many different data items may be collected as part of the historical results, such as any data or information relating to content items, content delivery campaigns, content providers, publishers, end users, and/or content delivery exchanges. Further, any of the collected data or information may be processed to generate other data, such as a winning resource reduction request amount distribution.

In step 205, a determination is made whether performance data of the content delivery campaign is available. Performance data includes prior results of a particular content delivery campaign, such as a CTR for the content delivery campaign. If performance data is available, the method proceeds to step 240. If performance data is not available, the method proceeds to step 210.

In step 210, a request is received to begin a content delivery campaign with the request having targeting criteria and a resource amount. The request may be received in any manner or format, and at any time. The request may identify or include additional information about the content delivery campaign, such as the content items for use in the content delivery campaign, or any other suitable information. At a minimum, the request identifies targeting criteria and a resource amount. The targeting criteria may be broad or narrow, and may identify one or more distinct groups or segments at which to direct the content delivery campaign. The resource amount may be for any time period, such as a daily resource amount, or a total resource amount for the duration of the content delivery campaign.

In step 215, relevant historical results of content item selection events for the targeting criteria of the content delivery campaign are determined. The relevant historical results may be determined by accessing a database with historical results and identifying the historical results relevant to the targeting criteria. Alternatively, the historical results may be calculated in response to receiving the request to begin the content delivery campaign, or may be determined in any other manner.

In step 220, a suggested resource reduction request amount is determined using the historical results and resource amount. The suggested resource reduction request amount provides guidance for a content provider as to how much the content provider should request to reduce their resource amount by per impression, click, or other method, so that their resource amount is used efficiently. The suggested resource reduction request amount may be a single value, a range, or both a single value and a range.

The suggested resource reduction request amount may be calculated or determined in many different ways. For example, a winning resource reduction request amount distribution may be identified from the historical results in step 215, and used to identify a lower percentile and higher percentile of the winning resource reduction request amount distribution as guidelines for the suggested resource reduction request amount. The lower percentile and the higher percentile may be modified based on a bucket or range of resource amounts associated with the content delivery campaign.

Alternatively, a suggested resource reduction request amount may be determined by predicting resource usage. Resource usage may be predicted using: requests*winning rate*predicted CTR*average cost, where requests are the daily average requests from users who satisfy the targeting criteria of the campaign, winning rate is the historical winning resource request amount distribution, predicted CTR is an average CTR for the content exchange or targeting criteria, and average cost is calculated as discussed above. Thus, a resource reduction request which is predicted to use the daily (or other timeframe) resource amount may be determined.

In step 225, the suggested resource reduction request amount is displayed or caused to be displayed to a content provider. The suggested resource reduction request amount may be displayed in any manner at any time. For example, the suggested resource reduction request amount may be displayed next to or nearby where a content provider enters their resource reduction request amount during creation of a content delivery campaign.

In step 230, a resource reduction request amount is received from the content provider. The resource reduction request amount may be received in any form at any time. The resource reduction request amount may be the same as the suggested resource reduction request amount, may be within the range identified by the suggested resource reduction request amount, or may be different from/outside the range identified by the suggested resource reduction request amount. The resource reduction request amount will be used in the content delivery campaign.

In step 235, the resource reduction request amount is used in the content delivery campaign. The resource reduction request amount is used when attempting to place the content item(s) associated with the content delivery campaign in front of the end users who match the targeting criteria of the content delivery campaign. The resource reduction request amount may be used for any length of time and may be updated or changed at any time.

In step 240, the suggested resource reduction request amount is determined using at least the performance data and the resource amount. In contrast to step 220, in step 240 performance data of the content delivery campaign is known, and thus a more accurate prediction of resource usage may be made. With performance data known, resource usage may be predicted as: impression volume*campaign CTR*average cost, where impression volume is an impression forecast for the targeting criteria+the content delivery campaign's impression share at the given resource reduction request amount, campaign CTR is calculated as discussed above, and average cost is calculated as discussed above. Using this, a highly accurate predicted resource usage may be determined.

Using this process, resource reduction request amounts may be suggested to content providers in real or near-real time, thereby providing valuable guidance and feedback to the content providers. This improves the ability of the content providers to accurately and efficiently deliver their content items, as well as increasing the efficiency of the content delivery exchange. The increased efficiency results in decreased memory usage and/or processing time by the content delivery exchange, because fewer superfluous resource reduction requests may be received.

### Example

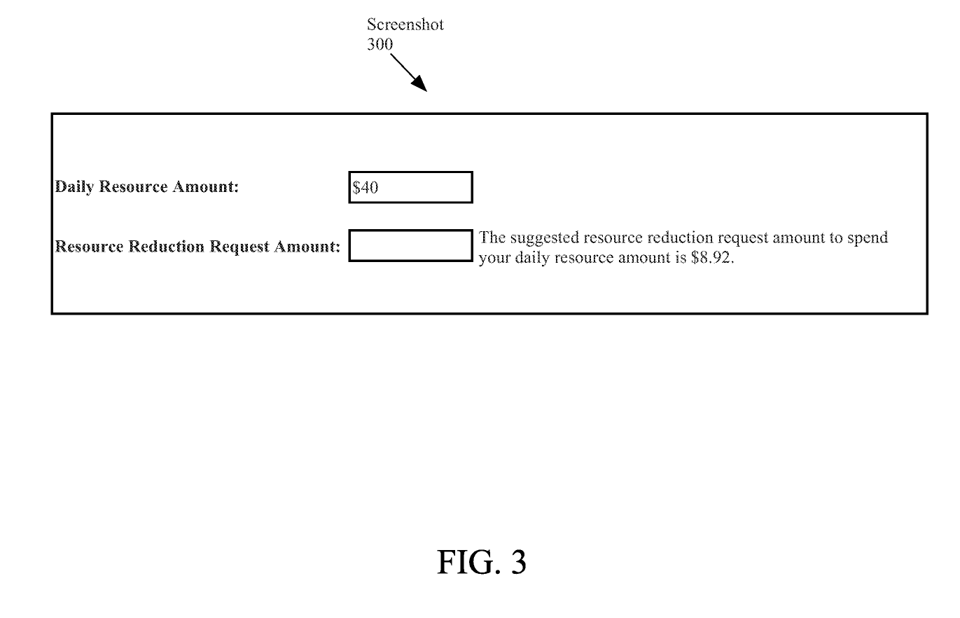

FIG. 3 shows a screenshot in accordance with one or more embodiments of the invention. Specifically, screenshot 300 shows a portion of an interface that may be used for suggesting a resource reduction request amount. After “$40” is entered as a daily resource amount, the suggested resource reduction request amount is determined using historical results while taking the $40 daily resource amount into consideration, such as using any of the methods discussed above. Subsequently, the actual resource reduction request amount is received via the same interface, and may subsequently be used in an associated content delivery campaign.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and program logic to implement the techniques.

For example, FIG. 3 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and instructions that cause a machine to operation in a specific fashion. Such storage media may comprise non-volatile media and volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and stored in storage device 410, or other non-volatile storage for later execution.

### Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more servers comprising one or more processors and electronic digital memory storing one or more sequences of instructions which, when executed by the one or more processors, cause the one or more processors to perform:
receiving, from a content provider, a request to begin a content delivery campaign, wherein the request comprises one or more targeting criteria and a resource amount;
prior to beginning the content delivery campaign, determining, based on the one or more targeting criteria, historical results of a plurality of content item selection events;
prior to beginning the content delivery campaign:
determining, based on the one or more targeting criteria, a suggested resource reduction request amount using the historical results and the resource amount, wherein the suggested resource reduction request amount reduces at least a portion of the resource amount within a predetermined timeframe;
causing the suggested resource reduction request amount to be displayed to the content provider;
receiving, from the content provider, a particular resource reduction request amount for the content delivery campaign;
initiating the content delivery campaign using the particular resource reduction request amount.

2. The system of claim 1, wherein the historical results comprise one or more of: a winning rate for the targeting criteria, a daily average requests for the one or more targeting criteria, a predicted click-through rate (CTR), or an average cost for the one or more targeting criteria.

3. The system of claim 2, wherein determining a suggested resource reduction request amount comprises predicting resource usage by multiplying the daily average requests, the predicted CTR, the winning rate, and the average cost.

4. The system of claim 1, wherein the historical results comprise a winning resource reduction request amount distribution, the one or more sequences of instructions further causing the one or more processors to perform:
determining a preliminary resource reduction request amount based on the winning resource reduction request amount distribution;
determining a bucket of a plurality of buckets associated with the resource amount,
wherein determining the suggested resource reduction request amount comprises adjusting the preliminary resource reduction request amount based on the bucket.

5. The system of claim 1, wherein the suggested resource reduction request amount is determined without data relating to a performance of the content delivery campaign.

6. The system of claim 1, the one or more sequences of instructions further causing the one or more processors to perform:
receiving, after beginning the content delivery campaign, data relating to the performance of the content delivery campaign;
generating an updated suggested resource reduction request amount using at least the data relating to the performance of the content delivery campaign and the resource amount;
causing the updated suggested resource reduction request amount to be displayed to the content provider.

7. The system of claim 1, wherein:
the request comprises a duration of the content delivery campaign;
the resource amount is a total for the duration of the content delivery campaign;
the predetermined timeframe is a day;
the one or more sequences of instructions further causing the one or more processors to perform determining the portion of the resource amount by dividing the resource amount by the number of days in the duration of the content delivery campaign.

8. The system of claim 1, wherein the suggested resource reduction request amount comprises a range.

9. A method comprising:
receiving, from a content provider, a request to begin a content delivery campaign, wherein the request comprises one or more targeting criteria and a resource amount;
prior to beginning the content delivery campaign, determining, based on the one or more targeting criteria, historical results of a plurality of content item selection events;
prior to beginning the content delivery campaign:
determining, based on the one or more targeting criteria, a suggested resource reduction request amount using the historical results and the resource amount, wherein the suggested resource reduction request amount reduces at least a portion of the resource amount within a predetermined timeframe;
causing the suggested resource reduction request amount to be displayed to the content provider;
receiving, from the content provider, a particular resource reduction request amount for the content delivery campaign;
initiating the content delivery campaign using the particular resource reduction request amount.

10. The method of claim 9, wherein the historical results comprise one or more of: a winning rate for the targeting criteria, a daily average requests for the one or more targeting criteria, a predicted CTR, or an average cost for the one or more targeting criteria.

11. The method of claim 10, wherein determining a suggested resource reduction request amount comprises predicting resource usage by multiplying the daily average requests, the predicted CTR, the winning rate, and the average cost.

12. The method of claim 9, further comprising:
wherein the historical results comprise a winning resource reduction request amount distribution;
determining a preliminary resource reduction request amount based on the winning resource reduction request amount distribution;
determining a bucket of a plurality of buckets associated with the resource amount,
wherein determining the suggested resource reduction request amount comprises adjusting the preliminary resource reduction request amount based on the bucket.

13. The method of claim 9, wherein the suggested resource reduction request amount is determined without data relating to a performance of the content delivery campaign.

14. The method of claim 9, further comprising:
receiving, after beginning the content delivery campaign, data relating to the performance of the content delivery campaign;
generating an updated suggested resource reduction request amount using at least the data relating to the performance of the content delivery campaign and the resource amount;
causing the updated suggested resource reduction request amount to be displayed to the content provider.

15. The method of claim 9, further comprising:
wherein the request comprises a duration of the content delivery campaign;
wherein the resource amount is a total for the duration of the content delivery campaign;
wherein the predetermined timeframe is a day;
determining the portion of the resource amount by dividing the resource amount by the number of days in the duration of the content delivery campaign.

16. The method of claim 9, wherein the suggested resource reduction request amount comprises a range.

17. A method comprising:
receiving, after beginning a content delivery campaign, data relating to the performance of the content delivery campaign, wherein one or more targeting criteria and a resource amount were received for the content delivery campaign;
determining, based on at least the data relating to the performance of the content delivery campaign and the resource amount, a suggested resource reduction request amount, wherein the suggested resource reduction request amount reduces at least a portion of the resource amount within a predetermined timeframe;
causing the suggested resource reduction request amount to be displayed to the content provider;
receiving, from the content provider, a particular resource reduction request amount for the content delivery campaign;
using the particular resource reduction request amount for the content delivery campaign.

18. The method of claim 17, wherein the suggested resource reduction request amount comprises a range.

19. The method of claim 17, wherein the predetermined timeframe is a day.

20. The method of claim 17, wherein the performance of the content delivery campaign comprises a click through rate.
